(19) United States
(12) Patent Application Publication
(10) Pub. No.: US 2006/0080715 A1
(43) Pub. Date: Apr. 13, 2006

(54) Apparatus and method for processing VOD data in a mobile terminal

(75) Inventors: Dae-Gyue Park, Buk-gu (KR); Hyun-Wook Cho, Buk-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/140,971

(22) Filed: Jun. 1, 2005

(30) Foreign Application Priority Data
Oct. 8, 2004 (KR) 2004-80194

(51) Int. Cl. H04N 7/16; H04N 7/173

(52) U.S. Cl. 725/87; 725/100; 725/62

(57) ABSTRACT

Apparatus and method are provided for processing video on demand (VOD) video data in a mobile terminal capable of receiving a VOD service. An input window for VOD video data to be adjusted is displayed in preset frame rate (FR) adjust mode for adjusting an FR of the VOD video data to be received. When the FR of the VOD video data to be adjusted is input into the input window, the input FR of the VOD video data is transmitted to a server. When the VOD video data service is provided in a streaming manner, a user can adjust the FR of VOD video data through the method. Therefore, the user can receive video data such as advertisement broadcasting in which the user takes no interest at a low FR, thereby reducing unnecessary packet data fees.

### PRIORITY

This application claims the benefit under 35 U.S.C. 119(a) of an application entitled “METHOD FOR PROCESSING VOD DATA IN A MOBILE TERMINAL”, filed in the Korean Intellectual Property Office on Oct. 8, 2004 and assigned Serial No. 2004-80194, the entire contents of which are incorporated herein by reference.

### BACKGROUND OF THE INVENTION

1. Field of the Invention

The present invention relates generally to a mobile terminal. More particularly, the present invention relates to an apparatus and method for processing video on demand (VOD) data that adjusts a frame rate of VOD streaming in the mobile terminal having access to a VOD server.

2. Description of the Related Art

With the development of technology, mobile terminals perform various supplementary functions as well as a basic communication function. The supplementary functions include camera, camcorder, multimedia functions, and so on. The multimedia function reproduces multimedia data in which voice, text, still and moving pictures, and the like are mixed. Using the multimedia function, the mobile terminal can receive a video on demand (VOD) service for providing multimedia content from a multimedia provider, that is, video data (hereinafter, referred to as “VOD video data”) such as movies or music videos, through a wireless network. The VOD service organizes VOD video data and provides the mobile terminal with the VOD video data through a wideband transmission path based on a cable or wireless link according to a user request. The user can enjoy the desired multimedia content through the VOD service in a streaming manner, that is, in real time.

When content is provided through the VOD service in the streaming manner, it must be received and decoded at a defined frame rate. Accordingly, there is a problem in that the user must pay unnecessary packet data fees to a network provider because of receiving advertisement broadcasts in which the user takes no interest as well as the primary broadcast in the same high video quality.

### SUMMARY OF THE INVENTION

Accordingly, the present invention has been designed to solve the above and other problems occurring in the prior art. Therefore, it is an aspect of the present invention to provide an apparatus and method that receive packet data at a frame rate adjusted by a user while a mobile terminal provides the user with content through a video on demand (VOD) service in a streaming manner.

The above and other aspects of the present invention can be achieved by an apparatus and method for processing video on demand (VOD) video data in a mobile terminal capable of receiving a VOD service. The apparatus and method include displaying an input window for VOD video data to be adjusted in a preset frame rate (FR) adjust mode for adjusting a FR of the VOD video data to be received; and when the FR of the VOD video data to be adjusted is input into the input window, transmitting the input FR of the VOD video data to a server.

### BRIEF DESCRIPTION OF THE DRAWINGS

The above and other aspects and advantages of the present invention will be more clearly understood from the following detailed description taken in conjunction with the accompanying drawings, in which:

FIG. 1 illustrates the format of a real time control protocol (RTCP) receiver report (RR) packet in accordance with an embodiment of the present invention;

FIG. 2 is a block diagram illustrating a video on demand (VOD) mobile terminal in accordance with an embodiment of the present invention; and

FIG. 3 is a flow chart illustrating a process for adjusting a frame rate of VOD streaming in accordance with an embodiment of the present invention.

Throughout the drawings, the same element is designated by the same reference numeral or character.

### DETAILED DESCRIPTION OF EXEMPLARY EMBODIMENTS

Embodiments of the present invention will be described in detail herein below with reference to the accompanying drawings. In the following description, a detailed description of known functions and configurations incorporated herein will be omitted for conciseness.

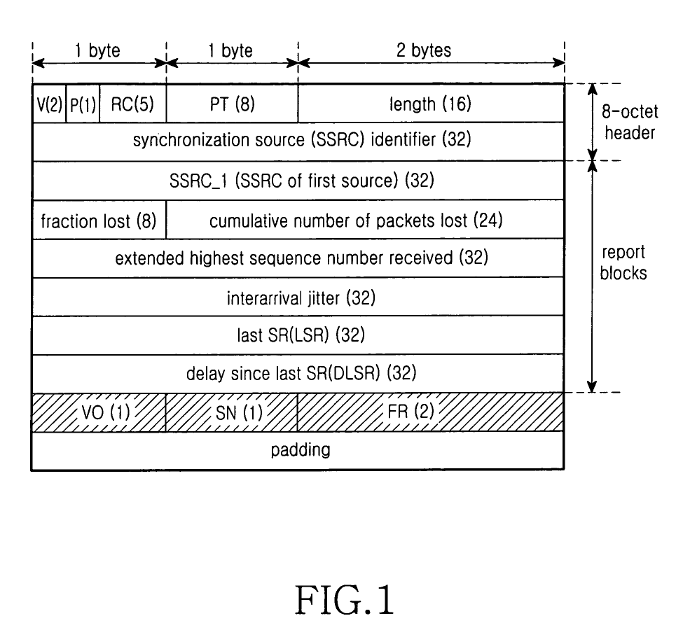

FIG. 1 illustrates the format of a real time control protocol (RTCP) receiver report (RR) packet in accordance with an embodiment of the present invention. Referring to FIG. 1, the RTCP RR packet includes an 8-octet header and at least one report block. The 8-octet header includes a version (V) field, a padding (P) field, a reception report count (RC) field, a packet type (PT) field, a length field, and a synchronization source RC (SSRC) identifier field. The V field indicates a 2-bit real time protocol (RTP) version, and the P field is a space for storing information specifying an unused storing space in terms of a fixed length block or record. The P field of 1 bit indicates if the packet includes padding. Eight bits are assigned to the PT field. The length field of 16 bits indicates the length of the RTCP packet including the header and padding. The SSRC identifier field consists of 32 bits. The report block includes an SSRC of first source (SSRC_1) field (32 bits), a fraction lost field (8 bits), a cumulative number of packets lost field (24 bits), an extended highest sequence number received field (32 bits), an interarrival jitter field (32 bits), a last SR time stamp (LSR) field (32 bits), and a delay since last SR (DLSR) field (32 bits). When the RTCP RR packet includes n number of report blocks, the n-th report block includes an SSRC of n-th source (SSRC_n) field. The RTCP RR packet includes a variation ON/OFF (VO) parameter (1 byte), a sequence number (SN) parameter (1 byte), and a frame rate (FR) parameter (2 bytes) in an extension field. Because an embodiment of the present invention is directly associated with the VO parameter (1 byte), the SN parameter (1 byte), and the FR parameter (2 bytes), a detailed description of other elements included in the RTCP RR packet is omitted for convenience. Variation of the FR begins when the 1-byte VO parameter is 11111111, and the variation of the FR ends when the 1-byte VO parameter is 00000000. Alternatively, the variation of the FR may begin when the 1-byte VO parameter is 00000000, and the variation of the FR may end when the 1-byte VO parameter is 11111111. The 1-byte SN parameter is incremented sequentially in the range from 0 to 255 and indicates an 8-bit wrap-around value. The FR parameter indicates a user's desired FR and has a value in the range from 1 to 30.

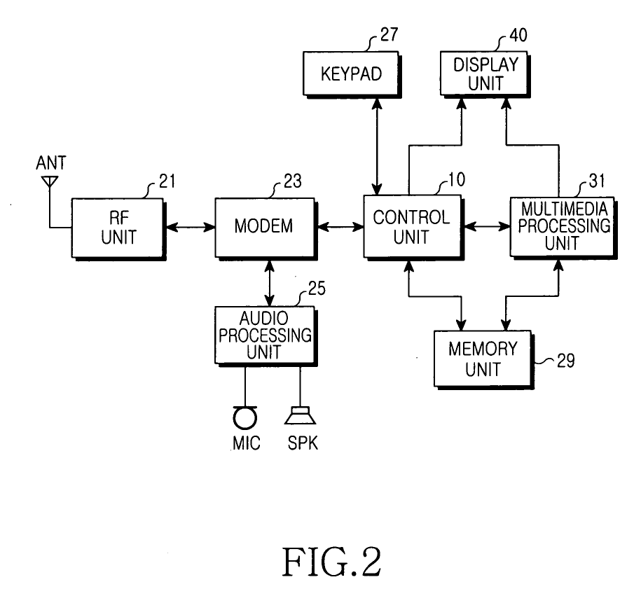

FIG. 2 is a block diagram illustrating a video on demand (VOD) mobile terminal in accordance with an embodiment of the present invention. Referring to FIG. 2, a radio frequency (RF) unit 21 performs a communication function for the mobile terminal. The RF unit 21 includes an RF transmitter (not shown) for up converting and amplifying a frequency of a signal to be transmitted and an RF receiver (not shown) for low-noise amplifying a received signal and down converting a frequency of the received signal. A modulator-demodulator (MODEM) 23 includes a transmitter (not shown) for coding and modulating the signal to be transmitted and a receiver (not shown) for demodulating and decoding the received signal. An audio processing unit 25 performs a function for reproducing a received audio signal output from the MODEM 23 or outputting a transmission audio signal generated from a microphone (MIC) to the MODEM 23. More specifically, the audio processing unit 25 outputs a voice signal of real-time VOD data to a speaker (SPK) in accordance with an embodiment of the present invention. A keypad 27 includes keys necessary to input number and letter information and function keys necessary to set various functions. More specifically, the keypad 27 can include VOD access, menu, direction, and OK keys, and so on in accordance with an embodiment of the present invention. A memory unit 29 can comprise program and data memories, and the like. The program memory can store programs for controlling the overall operation of the mobile terminal, and a program for processing VOD data in accordance with an embodiment of the present invention. A multimedia processing unit 31 processes VOD data received through a wireless network when the VOD service is provided. A control unit 10 controls the overall operation of the mobile terminal. More specifically, the control unit 10 recognizes that a VOD server access menu is selected, transmits an access signal to a VOD server. When the user adjusts a FR, the control unit 10 adjusts an RTCP RR packet according to the user's desired FR, and transmits the adjusted RTCP RR packet to the VOD server. In accordance with an embodiment of the present invention, a display unit 40 displays VOD data processed and output by the multimedia processing unit 31. More specifically, the display unit 40 displays an input window for adjusting the FR in FR adjust mode. The display unit 40 can use a liquid crystal display (LCD). In this case, the display unit 40 can include a LCD controller, a memory capable of storing image data, a LCD element, and so on. When the LCD is implemented using a touch-screen system, the keypad 27 and the LCD can serve as an input unit.

Operation of the mobile terminal will be described with reference to FIG. 2. When the user sets a signal transmission mode after a dialing operation through the keypad 27, the control unit 10 detects the set signal transmission mode, controls the MODEM 23 to process received dial information, and controls the RF unit 21 to convert the processed information into an RF signal and output the RF signal. Subsequently, when a called party generates a response signal, the control unit 10 detects the response signal through the RF unit 21 and the MODEM 23. The user performs a communication function by means of a voice communication path established through the audio processing unit 25. On the other hand, when signal reception mode is performed, the control unit 10 detects the signal reception mode through the MODEM 23 and controls the audio processing unit 25 to generate a ringtone. Subsequently, when the user responds, the control unit 10 detects the response. The user performs a communication function by means of a voice communication path established through the audio processing unit 25. Although an example of voice communication in the signal transmission and reception modes has been described above, a data communication function for communicating packet data and image data other than voice communication can also be performed without departing from the scope of the present invention. When an idle mode is entered, or character or text communication is performed, the control unit 10 controls the display unit 40 to display character or text data processed through the MODEM 23.

An operation for adjusting the FR of VOD streaming in the mobile terminal in accordance with an embodiment of the present invention will be described. The user can directly input the VOD access key through the keypad 27 or select an item corresponding to the VOD access key from a displayed menu through the OK key after inputting the menu key through the keypad 27. The control unit 10 detects key data generated from the VOD access key or the OK key, and then attempts to access the VOD server by transmitting an access signal to the VOD server. When the mobile terminal gains access to the VOD server and a session is established, the control unit 10 periodically exchanges an RTCP packet with the VOD server. In this case, when the user inputs a transmission rate through the keypad 27, the control unit 10 detects the input transmission rate, adjusts the RTCP packet according to an FR corresponding to the input transmission rate, and transmits the adjusted RTCP packet to the VOD server. The control unit 10 receives, from the VOD server, VOD video data at an adjusted transmission rate.

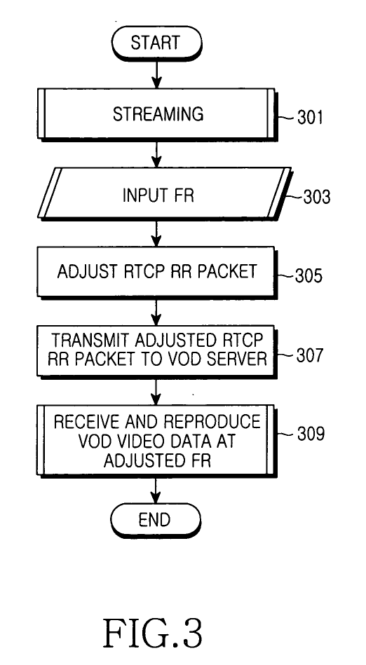

FIG. 3 is a flow chart illustrating a process for adjusting a FR of VOD streaming in accordance with an embodiment of the present invention. Referring to FIG. 3, the user directly inputs the VOD access key through the keypad 27 or selects an item corresponding to the VOD access key from a displayed menu through the OK key after inputting the menu key through the keypad 27, in the idle state. Then, the control unit 10 detects key data generated from the VOD access key or the OK key, and then transmits a VOD video service request signal to a base station. Then, the base station delivers, to the VOD server through a wired network, the VOD video service request signal transmitted through a wireless network. In response to the received video service request signal, the VOD server transmits predetermined video data to the mobile terminal through the base station. Then, the control unit 10 controls the multimedia processing unit 31 and the display unit 40 to process the VOD video data transmitted from the VOD server in a streaming manner in step 301. While a session is established, the mobile terminal periodically exchanges an RTCP packet with the VOD server. If video data in which the user takes no interest such as advertisement broadcasting rather than main broadcasting is transmitted while the VOD data is displayed in the streaming manner, the user inputs an FR adjust key for the VOD video data through the keypad 27 or selects an item corresponding to the FR adjust key from a displayed menu through the OK key after inputting the menu key through the keypad 27. Then, the control unit 10 detects the input FR adjust key or the selected item, enters into the FR adjust mode, and controls the display unit 40 to display an FR input window in step 303. When inputting a desired FR of VOD video data, for example, an FR value of 1, the user receives video data at 1 frame per second. When inputting 10 as the FR value of VOD video data, the user receives video data at 10 frames per second. A conventional FR value of VOD video data is 30, such that video data is received at 30 frames per second. According to the FR of the VOD video data input by the user, the control unit 10 sets the VO parameter of an RTCP RR packet to 11111111, increments the 1-byte SN parameter indicating the 8-bit wrap-around value in the range from 0 to 255 one by one, and adjusts the FR parameter to the FR of VOD video data input by the user in step 305. For example, when the user inputs 1 as the FR of VOD data, the control unit 10 sets the VO parameter to 11111111, and adjusts the FR parameter to 1. When the user inputs 10 as the FR of VOD video data, the control unit 10 sets the VO parameter to 11111111, and adjusts the FR parameter to 10. Alternatively, the variation of the FR may begin when the VO parameter is 00000000, and the variation of the FR may end when the VO parameter is 11111111. A value of the FR can be input in the range from 1 to 30. The user directly inputs a key for transmitting an adjusted RTCP RR packet through the keypad 27 or selects an item corresponding to the RTCP RR packet transmit key from a displayed menu through the OK key after inputting the menu key through the keypad 27. Then, the control unit 10 detects the input key or the selected item, and then controls the RF unit 21 and the MODEM 23 to transmit the adjusted RTCP RR packet to the VOD server in step 307. Subsequently, the VOD server detects the adjusted RTCP RR packet and then transmits VOD video data to the mobile terminal at an adjusted FR thereof. Then, the control unit 10 receives the VOD video data from the VOD server, and controls the multimedia processing unit 31 and the display unit 40 to reproduce the VOD video data at the adjusted FR thereof in step 309.

As apparent from the above description, the present invention provides a method for processing VOD video data in a mobile terminal by which a user can adjust a FR of VOD video data when a VOD video data service is provided in a streaming manner. The user can receive video data such as advertisement broadcasting in which the user takes no interest at a low FR, thereby reducing unnecessary packet data fees.

Although certain embodiments of the present invention have been disclosed for illustrative purposes, those skilled in the art will appreciate that various modifications, additions and substitutions are possible, without departing from the scope of the present invention. Therefore, the present invention is not limited to the above-described embodiments, but is defined by the following claims, along with their full scope of equivalents.

What is claimed is:

1. A method for processing video on demand (VOD) video data in a mobile terminal capable of receiving a VOD service, comprising:
displaying an input window for VOD video data to be adjusted in a preset frame rate (FR) adjust mode for adjusting a FR of the VOD video data to be received; and
when the FR of the VOD video data to be adjusted is input into the input window, transmitting the input FR of the VOD video data to a server.

2. The method according to claim 1, wherein the VOD video data is received in a streaming manner.

3. The method according to claim 1, further comprising:
adjusting a real time control protocol (RTCP) receiver report (RR) packet when the FR of the VOD video data to be adjusted is input.

4. The method according to claim 3, wherein the RTCP RR packet includes a variation ON/OFF parameter, a sequence number parameter, and a FR parameter.

5. The method according to claim 4, wherein the variation ON/OFF parameter indicates the beginning or end of a variation of the FR.

6. The method according to claim 4, wherein the FR parameter indicates the FR of the VOD video data.

7. The method according to claim 1, wherein the lower FR is charged at a reduced fee.

8. The method according to claim 1, wherein the unwanted content comprises advertising broadcasts.

9. The method according to claim 1, wherein the desired content comprises content a user requested to receive on the mobile terminal.

10. The method according to claim 1, wherein a user adjusts the FR.

11. An apparatus for processing video on demand (VOD) video data in a mobile terminal, comprising:
a display adapted to display an input window for VOD video data to be adjusted;
a controller adapted to adjust VOD video data in a preset frame rate (FR) adjust mode and transmit the input FR of the VOD video data to a server when the FR into the input window.

12. The apparatus according to claim 11, wherein the controller is adapted to receive the VOD video data in a streaming manner.

13. The apparatus according to claim 11, wherein the controller is further adapted to adjust a real time control protocol (RTCP) receiver report (RR) packet when the FR of the VOD video data to be adjusted is input.

14. The apparatus according to claim 13, wherein the RTCP RR packet includes a variation ON/OFF parameter, a sequence number parameter, and a FR parameter.

15. The apparatus according to claim 14, wherein the variation ON/OFF parameter indicates the beginning or end of a variation of the FR.

16. The apparatus according to claim 14, wherein the FR parameter indicates the FR of the VOD video data.

17. The apparatus according to claim 11, wherein the lower FR is charged at a reduced fee.

18. The apparatus according to claim 11, wherein the unwanted content comprises advertising broadcasts.

19. The apparatus according to claim 11, wherein the desired content comprises content a user requested to receive on the mobile terminal.

20. The apparatus according to claim 11, wherein the display comprises a liquid crystal display.
